(19) United States
(12) Patent Application Publication
(10) Pub. No.: US 2007/0208914 A1
(43) Pub. Date: Sep. 6, 2007

(54) DATA ACCESS APPARATUS WITH MULTIPLE BUSES AND METHOD THEREOF

(75) Inventors: Sen-Huang Tang, HSINCHU 300 (TW); Yi-Shu Chang, HSINCHU 300 (TW); Yu-Zoung Chou, HSINCHU 300 (TW); Chien-Hua Hsieh, HSINCHU 300 (TW)

Correspondence Address: ROSENBERG, KLEIN & LEE, 3458 ELLICOTT CENTER DRIVE-SUITE 101, ELLICOTT CITY, MD, 21043, US

(73) Assignee: REALTEK SEMICONDUCTOR CORP., HSINCHU 300 (TW)

(21) Appl. No.: 11/682,540

(22) Filed: Mar. 6, 2007

(30) Foreign Application Priority Data
Mar. 6, 2006 (TW) 095107476

(51) Int. Cl. G06F 13/00

(52) U.S. Cl. 711/154

(57) ABSTRACT

A memory access apparatus is disclosed. The apparatus comprising: a memory access module, having a first interface and a second interface; a first bus, coupled to the first interface; a first memory, coupled to the first bus, for storing a first data; a second bus, coupled to the second interface; and a second memory, coupled to the second bus, for storing a second data; wherein said memory access module accesses said first memory or said second memory or both according to the using statuses of said first bus and said second bus.

### FIELD OF THE INVENTION

The present invention relates to a memory access apparatus, and more particularly to a data access apparatus with multiple buses.

### BACKGROUND OF THE INVENTION

In general, a system usually requires a memory space to store data for accessing and computing, and a common traditional method accesses a larger quantity of data from the memory by increasing the number of bits of a bus. However, this design and method seems to be able to solve the problem of accessing a large quantity of data from the memory, but it also gives rise to the following problems:

(a) It is necessary that a large FIFO buffer be used for temporarily storing the large quality of data.

(b) Since the addressed space of the memory address becomes larger, therefore it usually results in a waste of bus resources, when only a small quantity of data is accessed.

(c) If a low-speed block (ex: memory access module or hardware module) and a high-speed block are coupled to a single bus, then the high-speed block will have to wait for the low-speed block to complete the access of the bus and the performance of high-speed block will be decreased.

(d) The throughput of the bus still depends on the access speed of the memory.

### SUMMARY OF THE INVENTION

In view of the description above, the inventor of the present invention discloses a memory access apparatus with multiple buses.

Therefore, it is an objective of the present invention to provide a memory access module and a plurality of buses for accessing at least two memories, wherein the memory access module can access different buses according to characteristics of the at least two memories.

The present invention further provides a data access apparatus with multiple buses and a method thereof. The apparatus includes at least one memory access module coupled to multiple buses to access a memory through any one of the buses. If the using bandwidth of a certain bus is found to be approaching its maximum bandwidth, then the memory access module will be used the other buse to improve the performance of this system.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

The subject matter regarded as the invention is particularly pointed out and distinctly claimed in the concluding portion of the specification. The invention, both as to device and method of operation, together with features and advantages thereof may best be understood by reference to the following detailed description with the accompanying drawings in which:

FIG. 1 is a block diagram of a data access apparatus with multiple buses in accordance to a preferred embodiment of the present invention;

FIG. 2 is a block diagram of an actual example of FIG. 1;

FIG. 3 is a flow chart of a method of accessing data by a multiple of buses; and

FIG. 4 is a block diagram of a data access apparatus with multiple buses in accordance with another preferred embodiment of the present invention.

### DETAILED DESCRIPTION OF THE PREFERRED EMBODIMENTS

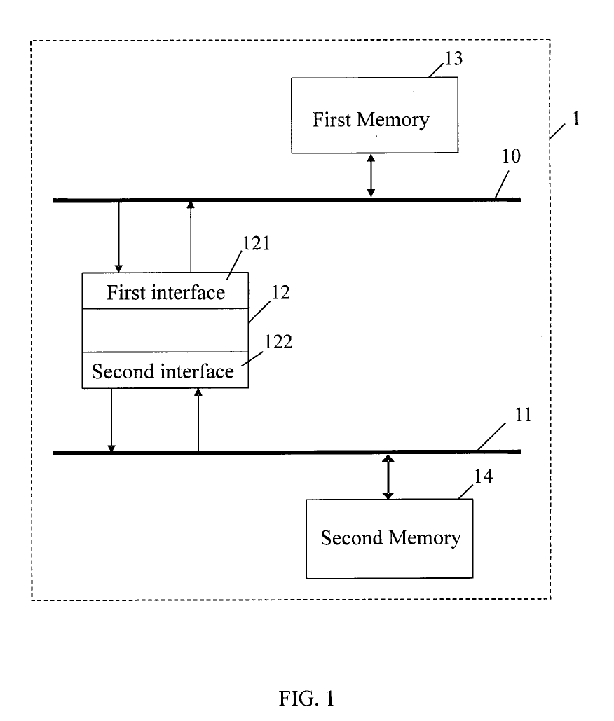

FIG. 1 shows a data access apparatus with multiple buses in accordance with a preferred embodiment of the invention. The data access apparatus 1 comprises a plurality of buses (ex: a first bus 10, a second bus 11), a memory access module 12, a first memory 13 and a second memory 14. The first bus 10 is coupled to the first memory 13 and the memory access module 12, wherein the memory access module 12 accesses the first memory 13 through the first interface 121 and the first bus 10. The second bus 11 is coupled to the second memory 14 and the memory access module 12, wherein the memory access module 12 accesses the second memory 14 through the second interface 122 and the second bus 11. In an embodiment, both the first interface 121 and the second 122 include a plurality of address lines, a plurality of data lines, and at least one of control signal.

The first interface 121 further comprises a circuit providing a chip select signal CS or a header of the first bus 10 for informing the first memory 13 and the memory access module 12 accesses the first memory 13 through the first bus 10. Similarly, the second interface 122 also comprises a circuit providing a control signal or a header of the second bus 11 for informing the second memory 14 and the memory access module 12 accesses the second memory 14 through the second bus 11.

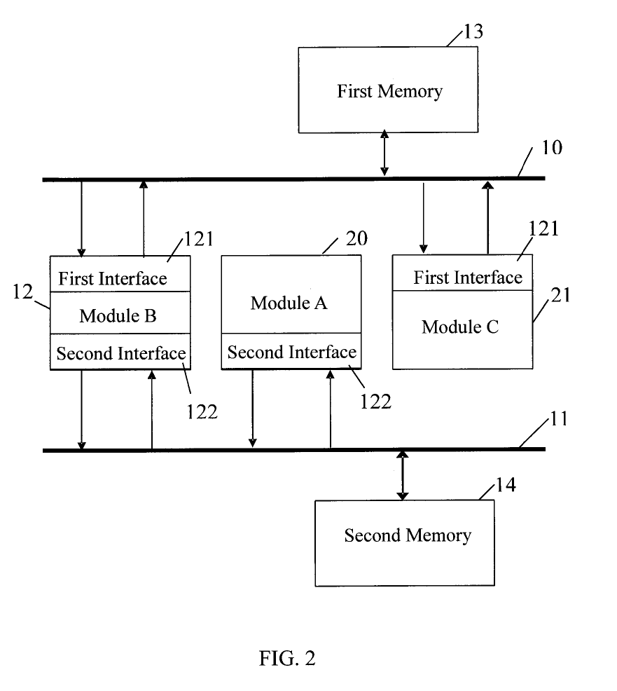

Referring to FIG. 2 for a block diagram of an actual example of FIG. 1, the bandwidth of the first bus 10 is a 128 Mbyte/sec, and the first memory 13 is a double data rate (DDR) memory. The bandwidth of the second bus 11 is a 64 Mbyte/sec (ex: MPEG bus), and the second memory 13 is a double data rate II (DDRII) memory.

In FIG. 2, a module A (20) comprises a second interface 122 coupled to the second bus 11 for accessing the second memory 14. Because the module A (20) is not coupled to a first memory 13, the module A (20) cannot access the first memory 13. Similarly, a module C (21) has a first interface 121 coupled to the first bus 10, and is not coupled to the second memory 14, so the module C (21) cannot access the second memory 14 through the second bus 11.

A module B (12) is coupled to the buses 10, 11 through the two interfaces 121, 122 respectively. If the bandwidth that the module B (12) needs is much smaller than 64 Mbyte/second, then the module B (12) can use the second bus 11 to temporarily store data in the second memory 14 or use the first bus 10 to access data temporarily stored in the first memory 13. If the module B (12) detects that any other circuit (such as the module C) is using the first bus 10, then the module B (12) will use the second bus 11 to temporarily store data in the second memory 14.

If the bandwidth that the module B (12) needs is much greater than 64 Mbyte/sec, then the module B (12) can still use the first bus 10 to access the content of data temporarily stored in the first memory 13. If the bandwidth of the bus occupied by the module B (12) exceeds 128 Mbyte/sec, then the module B (12) can access the content of data temporarily stored in the first memory 13 through the first bus 10 and the content of data temporarily stored in the second memory 14 through the second bus 11 simultaneously. In other words, the module B (12) can determine to use a certain percentage of bandwidth of the first bus 10 according to the using status of the first bus 10 and a certain percentage of bandwidth of the second bus 11 according to the using status of the second bus 11, so that the bandwidth usage of the first bus 10 and second bus 11 can be optimized. In this embodiment, the maximum bandwidth of the apparatus of this invention is approximately equal to a sum of maximum bandwidths of the first and the second buses. Of course, the first interface and the second interface can share certain signal lines.

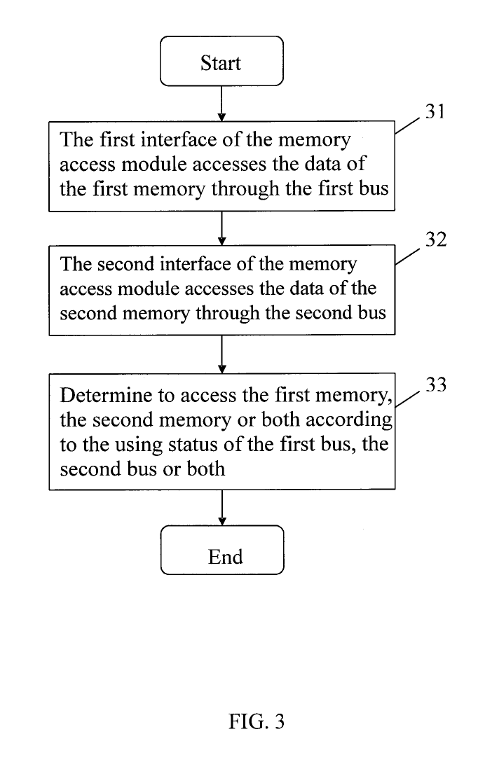

Referring to FIG. 3 for a flow chart of a data access method with multiple buses in accordance with this embodiment, the data access method comprises the steps of:

Step 31: accessing data of the first memory 13 by the first interface 121 of the memory access module 12 through the first bus 10;

Step 32: accessing data of the second memory 14 by the second interface 122 of the memory access module 12 through the second bus 11; and

Step 33: determining to access the first memory or the second memory or both according to the using status of the first bus 10 and the second bus 11.

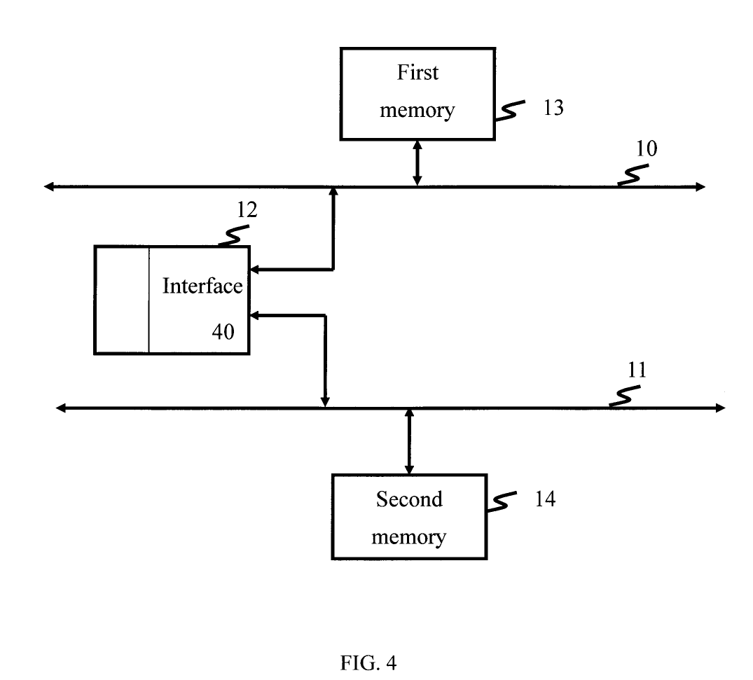

Referring to FIG. 4 for a data access apparatus with multiple buses in accordance with another preferred embodiment of the present invention, the first interface 121 and the second interface 122 can be combined to a single interface 40, if the first memory 13 and the second memory 14 come with a non-overlapped memory addressing range. In this embodiment as shown in FIG. 4, the interface 40 which comprises the first interface 121 and the second interface 122 generates a chip select signal for noticing whether or not the first memory 13 and the second memory 14 will be accessed.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory access apparatus, comprising:
a memory access module, comprising a first interface and a second interface;
a first bus, coupled to said memory access module;
a first memory, coupled said first bus, wherein said memory access module accesses said first memory through said first interface;
a second bus, coupled to said memory access module; and
a second memory, coupled to said second bus, wherein said memory access module accesses said second memory through said second interface.

2. The apparatus of claim 1, wherein said first interface comprises a header of said first bus.

3. The apparatus of claim 1, wherein said first interface comprises a chip select signal.

4. The apparatus of claim 1, wherein said first bus includes a plurality of address lines, a plurality of data lines, and at least one of control signal for accessing said first memory.

5. The apparatus of claim 1, wherein said memory access module simultaneously accesses said first memory and said second memory.

6. A method for accessing first and second memories through first and second buses, comprising:
accessing the first memory by the first bus through a first interface;
accessing the second memory by the second bus through a second interface; and
determining to access said first memory, said second memory or both according to using statuses of said first bus and said second bus.

7. The method of claim 6, wherein said first interface includes a header of said first bus.

8. The method of claim 7, wherein said header of said first bus includes a memory address for accessing said first memory.

9. The method of claim 7, wherein said second interface includes a header of said second bus.

10. The method of claim 9, wherein said header of said second bus includes a memory address for accessing said second memory.

11. The method of claim 7, wherein said first memory and said second memory are accessed simultaneously.

12. The method of claim 7, wherein said first interface includes a plurality of address lines and data lines, and at least one of control signals.

13. The method of claim 7, wherein an addressing range of said first memory and said second memory are non-overlapped.

14. A memory access apparatus, comprising:
a memory access module, having a first interface and a second interface;
a first bus, coupled to the first interface;
a first memory, coupled to the first bus, for storing a first data;
a second bus, coupled to the second interface; and
a second memory, coupled to the second bus, for storing a second data;
wherein said memory access module accesses said first memory or said second memory or both according to the using statuses of said first bus and said second bus.

15. The apparatus of claim 14, wherein an addressing range of said first memory and said second memory are non-overlapped.

16. The apparatus of claim 14, wherein said memory access module accesses said first memory and said second memory simultaneously.

17. The apparatus of claim 14, wherein both said first interface and said second interface comprise a chip select signal.

18. The apparatus of claim 14, wherein a maximum bandwidth of the apparatus is approximately equal to a sum of maximum bandwidths of the first and the second buses.
